(19) United States
(12) Patent Application Publication
(10) Pub. No.: US 2024/0322943 A1
(43) Pub. Date: Sep. 26, 2024

(54) A Radio Receiver with an Iterative Neural Network, and Related Methods and Computer Programs

(71) Applicant: Nokia Solutions and Networks Oy, Espoo (FI)

(72) Inventors: Mikko Johannes Honkala, Espoo (FI); Dani Johannes KORPI, Helsinki (FI); Janne Matti Juhani HUTTUNEN, Espoo (FI)

(21) Appl. No.: 18/575,419

(22) PCT Filed: Jul. 2, 2021
(86) PCT No.: PCT/EP2021/068352

§ 371 Date: Dec. 29, 2023

(51) Int. Cl. H04L 1/00; G06N 3/08

(52) U.S. Cl. CPC H04L 1/0051; G06N 3/08; H04L 1/0057

(57) ABSTRACT

Radio receiver devices and related methods and computer programs are disclosed. A radio signal including information bits is received at a radio receiver device. The radio receiver device determines log-likelihood ratios, LLRs, of the information bits. The determining of the LLRs is performed by applying an iterative neural network, NN, to a frequency domain representation of the received radio signal over a transmission time interval, TTI. The iterative NN includes a single processing block iteratively executable to process the frequency domain representation of the received radio signal. The iterative NN is configured to output estimates of the LLRs based on the processing results of the single processing block.

### TECHNICAL FIELD

The disclosure relates generally to communications and, more particularly but not exclusively, to a radio receiver with an iterative neural network, as well as related methods and computer programs.

### BACKGROUND

Implementing digital radio receiver functionality with neural networks is an emerging concept in the field of wireless communications. At least some of such neural networks may allow a fast and efficient implementation of the radio receiver using, e.g., neural network chips and/or artificial intelligence (AI) accelerators. It is also likely that at least under some circumstances learning-based solutions may result in higher performance, for example, under particular channel conditions, high user equipment (UE) mobility, and/or with sparse reference signal configurations.

However, at least in some situations, when using a machine learning (ML) based radio receiver, the number of computation operations that need to be executed for every received transmission interval may be high, thus potentially leading into high average power usage and latency. Yet, often channel conditions and noise conditions would allow detecting received bits using significantly less computational resources.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of a radio receiver device comprises at least one processor, and at least one memory including computer program code. The at least one memory and the computer program code are configured to, with the at least one processor, cause the radio receiver device to at least perform receiving a radio signal comprising information bits, and determining log-likelihood ratios, LLRs, of the information bits. The determining of the LLRs is performed by applying an iterative neural network, NN, to a frequency domain representation of the received radio signal over a transmission time interval, TTI. The iterative NN comprises a single processing block iteratively executable to process the frequency domain representation of the received radio signal. The iterative NN is configured to output estimates of the LLRs based on the processing results of the single processing block.

In an example embodiment, alternatively or in addition to the above-described example embodiments, the iterative NN further comprises a detection block executable after each executed iteration of the single processing block and configured to provide the estimates of the LLRs based on the processing results of the single processing block.

In an example embodiment, alternatively or in addition to the above-described example embodiments, the single processing block comprises at least two deep residual learning blocks, each deep residual learning block comprising at least two convolutional layers.

In an example embodiment, alternatively or in addition to the above-described example embodiments, the detection block comprises a 1×1 convolutional layer.

In an example embodiment, alternatively or in addition to the above-described example embodiments, the single processing block is configured to share its weights between the iterations.

In an example embodiment, alternatively or in addition to the above-described example embodiments, an input to a next iteration of the single processing block comprises an output of the detection block and an output of an immediately previous iteration of the single processing block.

In an example embodiment, alternatively or in addition to the above-described example embodiments, the at least one memory and the computer program code are further configured to, with the at least one processor, cause the radio receiver device to perform executing iterations of the single processing block until a predefined stopping condition is satisfied.

In an example embodiment, alternatively or in addition to the above-described example embodiments, the stopping condition comprises a required probability of success of a reference process.

In an example embodiment, alternatively or in addition to the above-described example embodiments, the received information bits comprise low-density parity-check, LDPC, encoded information bits, and the at least one memory and the computer program code are further configured to, with the at least one processor, cause the radio receiver device to perform providing the determined LLRs to LDPC decoding.

In an example embodiment, alternatively or in addition to the above-described example embodiments, the stopping condition comprises a required probability of success of the LDPC decoding.

In an example embodiment, alternatively or in addition to the above-described example embodiments, the at least one memory and the computer program code are further configured to, with the at least one processor, cause the radio receiver device to perform training the single processing block by applying a loss after each executed iteration.

In an example embodiment, alternatively or in addition to the above-described example embodiments, the loss comprises a cross-entropy loss.

In an example embodiment, alternatively or in addition to the above-described example embodiments, an overall loss comprises N+1 individual loss terms, and the at least one memory and the computer program code are further configured to, with the at least one processor, cause the radio receiver device to perform the training of the single processing block by executing N iterations.

In an example embodiment, alternatively or in addition to the above-described example embodiments, the at least one memory and the computer program code are further configured to, with the at least one processor, cause the radio receiver device to perform training the stopping condition to the single processing block based on success of the LDPC decoding.

In an example embodiment, alternatively or in addition to the above-described example embodiments, the received radio signal comprises an orthogonal frequency-division multiplexing, OFDM, radio signal.

In an example embodiment, alternatively or in addition to the above-described example embodiments, the radio receiver device comprises a multiple-input and multiple-output, MIMO, capable radio receiver device.

An example embodiment of a radio receiver device comprises means for performing: receiving a radio signal comprising information bits, and determining log-likelihood ratios, LLRs, of the information bits. The determining of the LLRs is performed by applying an iterative neural network, NN, to a frequency domain representation of the received radio signal over a transmission time interval, TTI. The iterative NN comprises a single processing block iteratively executable to process the frequency domain representation of the received radio signal. The iterative NN is configured to output estimates of the LLRs based on the processing results of the single processing block.

An example embodiment of a method comprises: receiving, at a radio receiver device, a radio signal comprising information bits, and determining, by the radio receiver device, log-likelihood ratios, LLRs, of the information bits. The determining of the LLRs is performed by applying an iterative neural network, NN, to a frequency domain representation of the received radio signal over a transmission time interval, TTI. The iterative NN comprises a single processing block iteratively executable to process the frequency domain representation of the received radio signal. The iterative NN is configured to output estimates of the LLRs based on the processing results of the single processing block.

In an example embodiment, alternatively or in addition to the above-described example embodiments, the iterative NN further comprises a detection block executable after each executed iteration of the single processing block and configured to provide the estimates of the LLRs based on the processing results of the single processing block.

In an example embodiment, alternatively or in addition to the above-described example embodiments, the single processing block comprises at least two deep residual learning blocks, each deep residual learning block comprising at least two convolutional layers.

In an example embodiment, alternatively or in addition to the above-described example embodiments, the detection block comprises a 1×1 convolutional layer.

In an example embodiment, alternatively or in addition to the above-described example embodiments, the single processing block is configured to share its weights between the iterations.

In an example embodiment, alternatively or in addition to the above-described example embodiments, an input to a next iteration of the single processing block comprises an output of the detection block and an output of an immediately previous iteration of the single processing block.

In an example embodiment, alternatively or in addition to the above-described example embodiments, the method further comprises executing, by the radio receiver device, iterations of the single processing block until a predefined stopping condition is satisfied.

In an example embodiment, alternatively or in addition to the above-described example embodiments, the stopping condition comprises a required probability of success of a reference process.

In an example embodiment, alternatively or in addition to the above-described example embodiments, the received information bits comprise low-density parity-check, LDPC, encoded information bits, and the method further comprises providing, by the radio receiver device, the determined LLRs to LDPC decoding.

In an example embodiment, alternatively or in addition to the above-described example embodiments, the stopping condition comprises a required probability of success of the LDPC decoding.

In an example embodiment, alternatively or in addition to the above-described example embodiments, the method further comprises training, by the radio receiver device, the single processing block by applying a loss after each executed iteration.

In an example embodiment, alternatively or in addition to the above-described example embodiments, the loss comprises a cross-entropy loss.

In an example embodiment, alternatively or in addition to the above-described example embodiments, an overall loss comprises N+1 individual loss terms, and the training of the single processing block is performed by executing N iterations.

In an example embodiment, alternatively or in addition to the above-described example embodiments, the method further comprises training, by the radio receiver device, the stopping condition to the single processing block based on success of the LDPC decoding.

In an example embodiment, alternatively or in addition to the above-described example embodiments, the received radio signal comprises an orthogonal frequency-division multiplexing, OFDM, radio signal.

In an example embodiment, alternatively or in addition to the above-described example embodiments, the radio receiver device comprises a multiple-input and multiple-output, MIMO, capable radio receiver device.

An example embodiment of a computer program comprises instructions for causing a radio receiver device to perform at least the following: receiving a radio signal comprising information bits, and determining log-likelihood ratios, LLRs, of the information bits. The determining of the LLRs is performed by applying an iterative neural network, NN, to a frequency domain representation of the received radio signal over a transmission time interval, TTI. The iterative NN comprises a single processing block iteratively executable to process the frequency domain representation of the received radio signal. The iterative NN is configured to output estimates of the LLRs based on the processing results of the single processing block.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example iterative neural network, where various embodiments of the present disclosure may be implemented;

FIG. 2 shows an example embodiment of the subject matter described herein illustrating a radio receiver device;

FIG. 3A shows an example embodiment of the subject matter described herein illustrating an example implementation of a single iteratively executable processing block and a detection block;

FIG. 3B shows an example embodiment of the subject matter described herein illustrating another example implementation of the single iteratively executable processing block and the detection block; and

FIG. 4 shows an example embodiment of the subject matter described herein illustrating a method.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

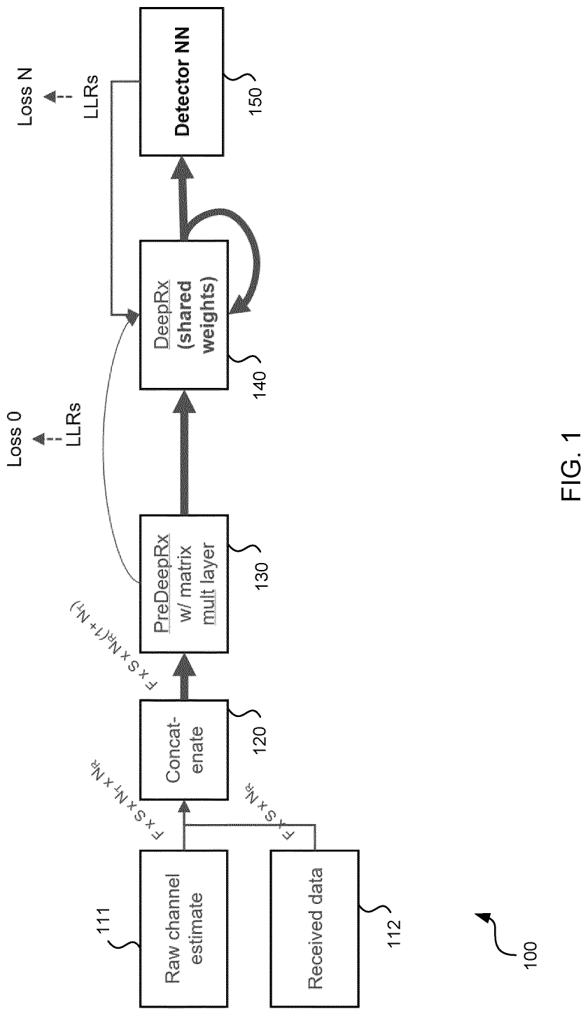

FIG. 1 illustrates an example iterative neural network (NN) 100, which may be implemented in various embodiments of the present disclosure. At least in some embodiments, the iterative NN 100 may comprise an iterative convolutional neural network (CNN). The CNN may comprise one or more convolutional layers. At least in some other embodiments, the iterative NN 100 may comprise an iterative transformer neural network. The iterative transformer NN may comprise one or more transformer layers.

As disclosed herein, the term “convolutional neural network” indicates that the network employs a mathematical operation called convolution. Convolutional networks are a type of neural networks that use convolution in place of general matrix multiplication in at least one of their layers.

Convolutional neural networks comprise multiple layers of artificial neurons. Artificial neurons are mathematical functions that calculate the weighted sum of multiple inputs, and output an activation value. The behaviour of each neuron is defined by its weights. The process of adjusting these weights is called “training” the neural network.

In other words, each neuron in a neural network computes an output value by applying a specific function to the input values received from a receptive field in a previous layer. The function that is applied to the input values is determined by a vector of weights and a bias. Learning consists of iteratively adjusting these biases and weights. The vector of weights and the bias are called filters and represent particular features of the input.

Input to the iterative neural network 100 includes received data 112 (e.g., a received radio signal after a fast Fourier transform (FFT) applied by, e.g., a radio receiver) over a single transmission time interval (TTI). Input to the iterative neural network 100 may further include a raw channel estimate 111 over the TTI. The raw channel estimate may be calculated, e.g., by using demodulation reference signals (DMRS), also referred to as pilots. In MIMO transmissions, each layer has its own pilots, which are separated from the pilots of other layers in frequency, time, and/or code domain.

In FIG. 1, N_{T} represents the number of layers or spatial streams in a MIMO system, and N_{R} represents the number of receive antennas in the MIMO system. S represents the number of orthogonal frequency-division multiplexing (OFDM) symbols within a TTI. Typically, S=14 in fifth generation (5G) new radio (NR) wireless networks. F represents the number utilized subcarriers.

The received data 112 and the raw channel estimate 111 may be combined or concatenated at block 120.

The iterative neural network 100 may optionally further comprise a MIMO preprocessing block 130 (PreDeepRx) which may comprise a deep residual learning network (ResNet). For example, the MIMO preprocessing block 130 may comprise a complex valued ResNet that may include at least one part that is configured to express multiplication and/or complex-conjugate multiplication between its inputs. It may be beneficial in radio processing to allow this kind of operation, since the radio channel noise is multiplicative in nature. The MIMO preprocessing block 130 may further comprise other parts that are normal ResNets, namely multiplying their inputs by their weights.

The iterative neural network 100 further comprises a single processing block 140 and a detection block 150 that will be discussed in more detail below. The single processing block 140 is executed/iterated multiple times, and the detection block 150 is executed after each iteration.

In the following, various example embodiments will be discussed. At least some of these example embodiments may allow an iterative machine learning (ML) based radio receiver architecture and a training method for this architecture. The disclosed approach allows changing the number of iterations at runtime based on, e.g., available computational resources, setup and/or environment (e.g., number of overlapping layers in a MIMO transmission, or difficulties related to channel conditions and/or noise conditions). In other words, the disclosed approach allows varying the depth of the ML-based radio receiver during inference.

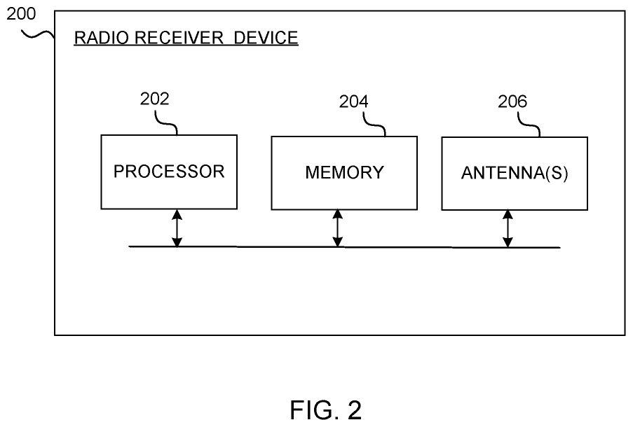

FIG. 2 is a block diagram of the radio receiver device 200, in accordance with an example embodiment.

The radio receiver device 200 comprises one or more processors 202 and one or more memories 204 that comprise computer program code. The radio receiver device 200 may be configured to receive information from other devices. In one example, the radio receiver device 200 may receive signalling information and data in accordance with at least one cellular communication protocol. The radio receiver device 200 may be configured to provide at least one wireless radio connection, such as for example a 3GPP mobile broadband connection (e.g., 5G). The radio receiver device 200 may comprise, or be configured to be coupled to, at least one antenna 206 to receive radio frequency signals.

Although the radio receiver device 200 is depicted to include only one processor 202, the radio receiver device 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments, such as the iterative neural network 100.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network chip, an artificial intelligence (AI) accelerator, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

It is also possible to train one machine learning model with a specific architecture, then derive another machine learning model from that using processes such as compilation, pruning, quantization or distillation. The machine learning model can be executed using any suitable apparatus, for example a CPU, GPU, ASIC, FPGA, compute-in-memory, analog, or digital, or optical apparatus. It is also possible to execute the machine learning model in an apparatus that combines features from any number of these, for instance digital-optical or analog-digital hybrids. In some examples, the weights and required computations in these systems may be programmed to correspond to the machine learning model. In some examples, the apparatus may be designed and manufactured so as to perform the task defined by the machine learning model so that the apparatus is configured to perform the task when it is manufactured without the apparatus being programmable as such.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The radio receiver device 200 may comprise any of various types of digital devices capable of receiving radio communication in a wireless network. At least in some embodiments, the radio receiver device 200 may be comprised in a base station, such as a fifth-generation base station (gNB) or any such device providing an air interface for client devices to connect to the wireless network via wireless transmissions. At least in some embodiments, the radio receiver device 200 may comprise a multiple-input and multiple-output (MIMO) capable radio receiver device.

The at least one memory 204 and the computer program code are configured to, with the at least one processor 202, cause the radio receiver device 200 to at least perform receiving a radio signal comprising information bits. For example, the received radio signal may comprise an orthogonal frequency-division multiplexing (OFDM) radio signal.

The at least one memory 204 and the computer program code are further configured to, with the at least one processor 202, cause the radio receiver device 200 to perform determining log-likelihood ratios (LLRs) of the information bits.

The determining of the LLRs is performed by applying an iterative neural network (NN) 100 to a frequency domain representation of the received radio signal over a transmission time interval (TTI). At least in some embodiments, the iterative NN 100 may comprise an iterative convolutional neural network (CNN). The CNN may comprise one or more convolutional layers. At least in some other embodiments, the iterative NN 100 may comprise an iterative transformer neural network. The iterative transformer NN may comprise one or more transformer layers.

The iterative NN 100 comprises a single processing block 140 that is iteratively executable to process the frequency domain representation of the received radio signal. For example, the single processing block 140 may comprise at least two deep residual learning blocks, and each deep residual learning block may comprise at least two convolutional layers. The iterative NN 100 is configured to output estimates of the LLRs based on the processing results of the single processing block 140.

The iterative NN 100 may further comprise a detection block 150 that is executable after each executed iteration of the single processing block 140. The detection block 150 is configured to provide the estimates of the LLRs of the sent bits (to be output) based on the processing results of the single processing block 140. For example, the detection block 150 may comprise a 1×1 convolutional layer. In other embodiments, the detection block 150 functionality may be performed inside the processing block 140, i.e., there is no separate detection block.

In other words, at inference and without varying the depth of the iterative NN 100, the iterative NN 100 may be executed, e.g., as follows.

Assuming N represents the number of iterations, and M=1 represents iterations run, e.g., the following steps may be performed:
1. concatenate inputs 111, 112, and run the MIMO preprocessing block 130;
2. run the single processing block 140 and the detection block 150 once, outputting LLR estimates;
3. set M=M+1; and
4. if M>N, stop, otherwise repeat from 2.

At least in some embodiments, the single processing block 140 may be configured to share its weights between the iterations.

At least in some embodiments, an input to a next iteration of the single processing block 140 may comprise an output of the detection block 150 and an output of an immediately previous iteration of the single processing block 140.

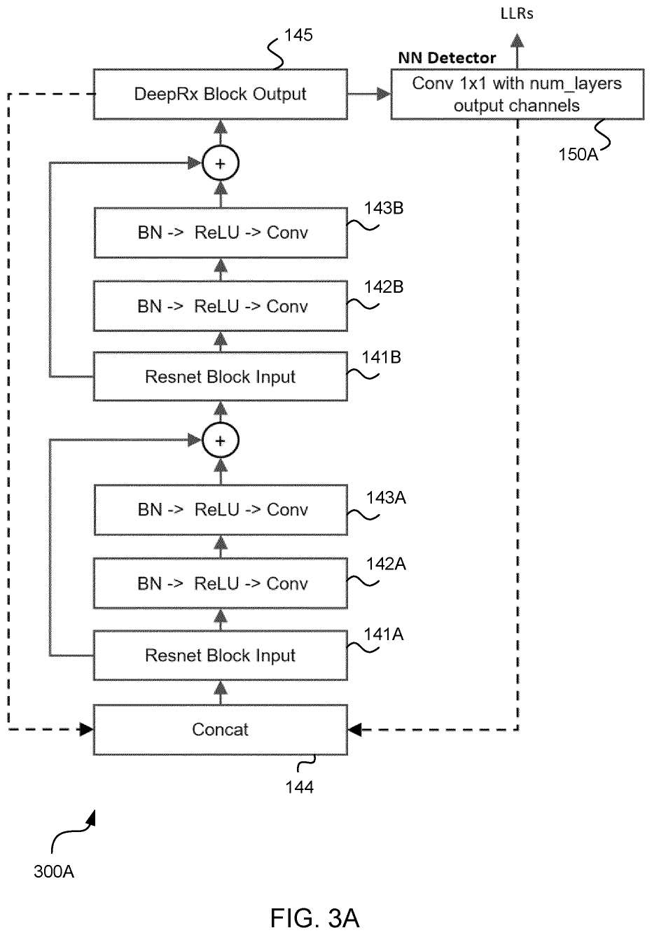

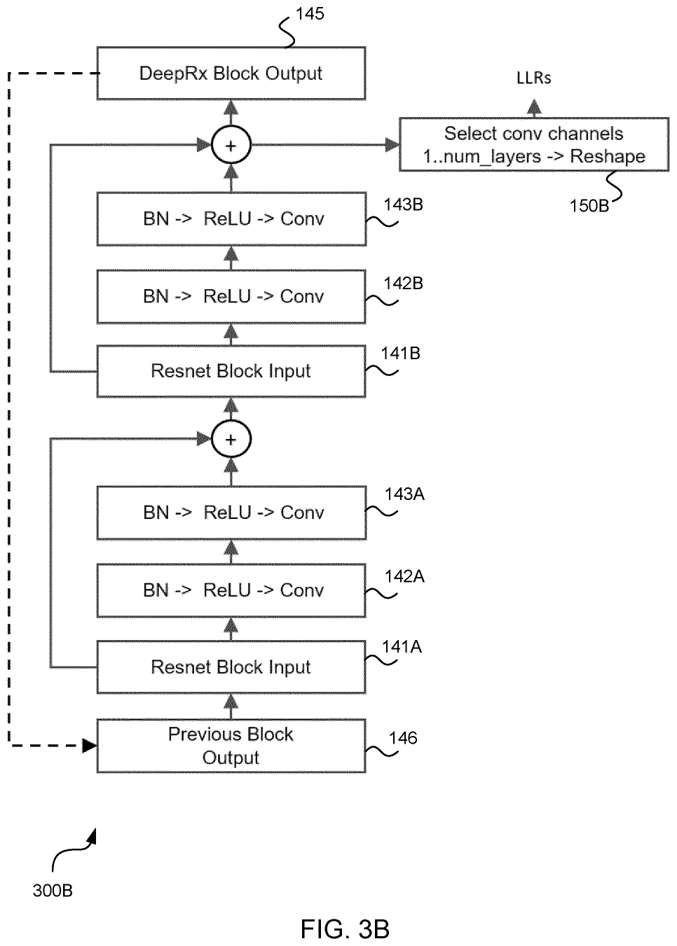

FIG. 3A shows a diagram 300A of a first example implementation of the single iteratively executable processing block 140 and the detection block 150, for a single iteration. FIG. 3B shows a diagram 300B of a second example implementation of the single iteratively executable processing block 140 and the detection block 150, for a single iteration.

141A, 141B represent inputs to deep residual learning network (ResNet) blocks. The ResNet blocks have two convolutional layers each (142A-143A, and 142B-143B). In FIGS. 3A and 3B, BN represents batch normalization, ReLU represents a rectified linear unit, and conv represents a convolutional layer. At least in some embodiments, advantages of a ResNet block may include being easy to train and being able to provide accurate results after training.

144 represents concatenation, and 145 represents output of the processing block 140. 146 represents previous output of the processing block 140. 150A represents a first embodiment of the detection block 150, and 150B represents a second embodiment of the detection block 150.

In the implementation of FIG. 3A, inputs to the next iteration are the detection block 150A output of LLRs and the processing block 140 output of the previous iteration. Input to the first block is the output of the MIMO preprocessing block 130 and LLRs given by the MIMO preprocessing block 130.

In the implementation of FIG. 3B, the detection block 150B is integrated inside the processing block 140. In other words, the processing block 140 and the detection block 150B have been joined together. The LLRs are produced by selecting N convolutional channels, where N represents the number of MIMO layers.

The at least one memory 204 and the computer program code may be further configured to, with the at least one processor 202, cause the radio receiver device 200 to perform executing iterations of the single processing block 140 until a predefined stopping condition is satisfied. For example, the stopping condition may comprise a required probability of success of a reference process.

At least in some embodiments, the received information bits may comprise low-density parity-check (LDPC) encoded information bits. The at least one memory 204 and the computer program code may be further configured to, with the at least one processor 202, cause the radio receiver device 200 to perform providing the determined LLRs to LDPC decoding. The LDPC decoding may process the LLRs to determine the information bits contained in the received radio signal. At least in some of these embodiments, the stopping condition may comprise a required probability of success of the LDPC decoding.

In other words, while the iterations can be stopped when the bits can be decoded perfectly (and this condition could be observed by the LDPC that decodes the LLRs after each iteration), such decoding may be computationally expensive. This expense may be avoided by using a model which predicts the remaining iterations needed, e.g., as follows.

Assuming P represents the probability of LDPC success that is required from the system (e.g., 0.95), input may comprise Xₛₜₒₚ concatenation of the output of the single processing block 140 with the LLR estimates, and output may comprise i\hat{ } estimated number of iterations needed until P success rate of the LDPC encoding. For this, k ResNet NN layers may be used, followed by t fully connected layers.

In other words, the stopping condition may be used at inference time for varying the depth of the iterative NN 100. The stopping condition may be evaluated after each iteration, and it may output the estimated remaining iterations before decoding will be successful. Using a trained variable depth model may be done, e.g., as follows.

Assuming P represents a threshold probability (e.g., 95%) indicating how large percentage of success is required, n represents a maximum number of iterations, and NNₛₜₒₚ represents a trained stop NN that outputs remaining iterations, e.g., the following steps may be performed:
1. run the MIMO preprocessing block 130;
2. for each iteration k in range (n):
   a. run the single processing block 140 and the detection block 150 once, outputting LLR estimates,
   b. set M=M+1,
   c. if M>N, stop iterating,
   d. otherwise, concatenate the output of the single processing block 140 with the LLR estimates into Xₛₜₒₚ and feed those through the NNₛₜₒₚ network which outputs a prediction of remaining iterations i\hat{ },
   e. if i\hat{ }==0, stop iterating,
   f. if (k+i\hat{ })>n, stop iterating.
3. once iterating is stopped, input the estimated LLRs to an LDPC decoder for a final result.

At least in some embodiments, the at least one memory 204 and the computer program code may be further configured to, with the at least one processor 202, cause the radio receiver device 200 to perform training the single processing block 140 by applying a loss after each executed iteration. For example, the loss may comprise a cross-entropy loss.

The cross-entropy loss may be defined, e.g., as:

$$CE ( b , \hat{b} ) = - \frac{1}{\# DB} {\sum }_{( i , j ) ∈ D} {\sum }_{l = 0}^{B - 1} ( {b}_{i j l} log {\hat{b}}_{i j l} + ( 1 - {b}_{i j l} ) log ( 1 - {\hat{b}}_{i j l} ) )$$

in which D represents a set of indices corresponding to resource elements carrying data, #D represents the number of such indices, B represents the number of samples in a sample batch, and \hat{b}ᵢⱼₗ represent predicted bit probabilities (\hat{b}ᵢⱼₗ=sigmoid (Lᵢⱼₗ), in which Lᵢⱼₗ is the output, i.e., the LLRs of the iterative NN 100.

In other words, the iterative processing block 140 may be trained by applying, e.g., the above described cross-entropy loss after each iteration.

At least in some embodiments, an overall loss may comprise N+1 individual loss terms, and the at least one memory 204 and the computer program code may be further configured to, with the at least one processor 202, cause the radio receiver device 200 to perform the training of the single processing block 140 by executing N iterations.

In other words, the overall loss may comprise N+1 individual loss terms that are summed together during the training:

$$C {E}_{i t e r} = C E ( b , {\hat{b}}^{( 0 )} ) + C E ( b , {\hat{b}}^{( 1 )} ) + … + C E ( b , {\hat{b}}^{( N )} )$$

in which \hat{b}^{(k)} represent predicted bit probabilities after a k^{th} iteration. The training may be performed so that the maximum number of iterations N is predefined, and this number of iterations may be executed during training. Optionally, each loss term may be weighted by multiplying it with a scalar, for example, such that a larger weight is given to the last terms. At least in some embodiments, this may allow achieving a lower cross-entropy with fewer iterations.

At least in some embodiments, the at least one memory 204 and the computer program code may be further configured to, with the at least one processor 202, cause the radio receiver device 200 to perform training the stopping condition to the single processing block 140 based on success of the LDPC decoding.

In other words, it is possible to train a stopping condition for the iterative NN 100. For example, this may be done after training the iterative NN 100 for a maximum N iterations, as described before.

Assuming N represents a maximum number of iterations, NNₛₜₒₚ represents untrained stopping NN to be trained (outputting remaining iterations), D (split into Dₜᵣₐᵢₙ, D_{valid}) represents an empty training database, and i represents remaining iterations=N, e.g., the following steps may be performed:

First, to collect data into D (run this for each data sample):
1. run the iterative NN 100 with only one execution of the single processing block 140 and the detection block 150 (M=1), outputting LLR estimates;
2. iterate until the LDPC is successful: for curr_iter=1 . . . N:
   a. run the single processing block 140 for the next iteration, producing updated LLR estimates,
      i. save the output of the single processing block 140 for step 3 below.
   b. input the LLRs into an LDPC decoder and output a binary value y (i.e., decoding successful or unsuccessful, based on CRC),
   c. if y==1 (LDPC successful), set i=curr_iter and exit loop. If the LDPC did not succeed, set i=N+1.
3. repeat the following steps for curr_iter=1 . . . min(i,N) to create data based on i from previous iterations:
   a. concatenate the output of the single processing block 140 (saved in step 2) with the LLR estimates from the detection block 150 into Xₛₜₒₚ,
   b. collect the pairs (Xₛₜₒₚ, icurr_iter), into the training and validation database D, then split the database into Dₜᵣₐᵢₙ, D_{valid}.

Then, to train the NNₛₜₒₚ:
1. iterate the training database, e.g. using a stochastic gradient descent (SGD) variant, such as LAMB algorithm for each pair (Xₛₜₒₚ, y) randomly and multiple times:
   a. feed Xₛₜₒₚ through the NNₛₜₒₚ network, which outputs a prediction of remaining iterations
   b. update the weights of NNₛₜₒₚ using the cross-entropy loss between i and i\hat{ },
   c. using D_{valid}, determine when to stop training, and that no overfitting is happening.

At least in some embodiments, the stopping condition may be trained simultaneously to training another part of the network. In such a case, the stopping condition may be considered an additional output of the iterative network, and the training sums together the two losses by using, e.g., empirically determined weights.

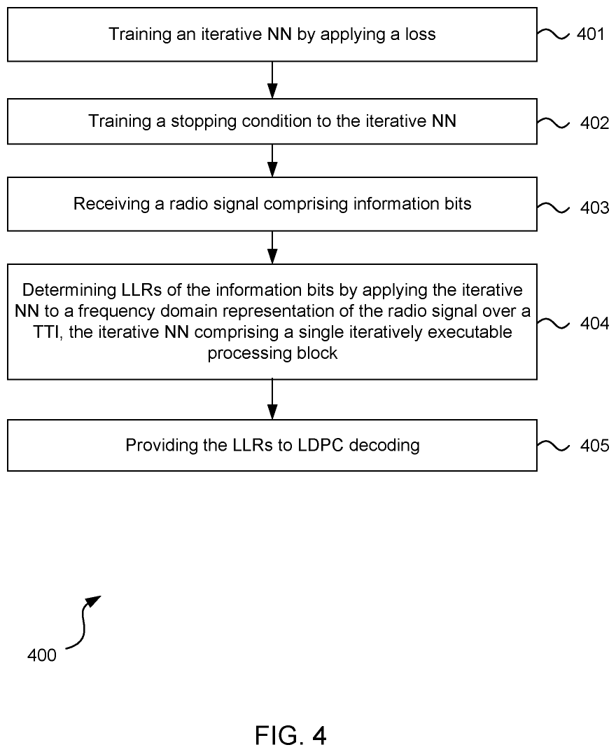

FIG. 4 illustrates an example flow chart of a method 400, in accordance with an example embodiment.

At optional operation 401, the radio receiver device 200 may train the single processing block 140 by applying a loss after each executed iteration.

At optional operation 402, the radio receiver device 200 may train the stopping condition to the single processing block 140 based on success of LDPC decoding.

At operation 403, the radio receiver device 200 receives a radio signal comprising information bits.

At operation 404, the radio receiver device 200 determines LLRs of the information bits. The determining of the LLRs is performed by applying an iterative NN 100 to a frequency domain representation of the received radio signal over a TTI. The iterative NN 100 comprises a single processing block 140 iteratively executable to process the frequency domain representation of the received radio signal. The iterative NN 100 is configured to output estimates of the LLRs based on the processing results of the single processing block 140.

At optional operation 405, the radio receiver device 200 may provide the determined LLRs to LDPC decoding.

The method 400 may be performed by the radio receiver device 200 of FIG. 2. The operations 401-405 can, for example, be performed by the at least one processor 202 and the at least one memory 204. Further features of the method 400 directly result from the functionalities and parameters of the radio receiver device 200, and thus are not repeated here. The method 400 can be performed by computer program(s).

At least some of the embodiments described herein may allow aligning the run-time computational complexity of an ML based radio receiver with prevailing channel conditions. In other words, at least some of the embodiments described herein may allow using as little computations as possible for detecting the information bits from the received radio signal.

At least some of the embodiments described herein may allow improved performance.

At least some of the embodiments described herein may allow saving total/average power consumption at the radio receiver processing.

At least some of the embodiments described herein may allow lower average latency.

At least some of the embodiments described herein may allow saving computational resources that may be then utilized by other processing.

The radio receiver device 200 may comprise means for performing at least one method described herein. In one example, the means may comprise the at least one processor 202, and the at least one memory 204 including program code configured to, when executed by the at least one processor, cause the radio receiver device 200 to perform the method.

The functionality described herein can be performed, at least in part, by one or more computer program product components such as software components. According to an embodiment, the radio receiver device 200 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A radio receiver device, comprising:
at least one processor; and
at least one non-transitory memory storing instructions that, when executed with the at least one processor, cause the radio receiver device to at least perform:
receiving a radio signal comprising information bits; and
determining log-likelihood ratios of the information bits,
wherein the determining of the log-likelihood ratios is performed with applying an iterative neural network to a frequency domain representation of the received radio signal over a transmission time interval, the iterative neural network comprising a single processing block iteratively executable to process the frequency domain representation of the received radio signal, and the iterative neural network configured to output estimates of the log-likelihood ratios based on the processing results of the single processing block.

2. The radio receiver device according to claim 1, wherein the iterative neural network further comprises a detection block executable after an executed iteration of the single processing block and wherein the instructions, when executed with the at least one processor, cause the radio receiver device to provide the estimates of the log-likelihood ratios based on the processing results of the single processing block.

3. The radio receiver device according to claim 1, wherein the single processing block comprises at least two deep residual learning blocks, a deep residual learning block comprising at least two convolutional layers.

4. The radio receiver device according to claim 2, wherein the detection block comprises a 1×1 convolutional layer.

5. The radio receiver device according to claim 1, wherein the single processing block is configured to share its weights between the iterations.

6. The radio receiver device according to claim 2, wherein an input to a next iteration of the single processing block comprises an output of the detection block and an output of an immediately previous iteration of the single processing block.

7. The radio receiver device according to claim 1, wherein the instructions, when executed with the at least one processor, cause the radio receiver device to perform executing iterations of the single processing block until a predefined stopping condition is satisfied.

8. The radio receiver device according to claim 7, wherein the stopping condition comprises a required probability of success of a reference process.

9. The radio receiver device according to claim 7, wherein the received information bits comprise low-density parity-check encoded information bits, and the instructions, when executed with the at least one processor, cause the radio receiver device to perform providing the determined log-likelihood ratios to low-density parity-check decoding.

10. The radio receiver device according to claim 9, wherein the stopping condition comprises a required probability of success of the low-density parity-check decoding.

11. The radio receiver device according to claim 1, wherein the instructions, when executed with the at least one processor, cause the radio receiver device to perform training the single processing block with applying a loss after an executed iteration.

12. The radio receiver device according to claim 11, wherein the loss comprises a sum of one or more cross-entropy losses.

13. The radio receiver device according to claim 9, wherein the instructions, when executed with the at least one processor, cause the radio receiver device to perform training the stopping condition to the single processing block based on success of the low-density parity-check decoding.

14. The radio receiver device according to claim 1, wherein the received radio signal comprises an orthogonal frequency-division multiplexing radio signal.

15. The radio receiver device according to claim 1, wherein the radio receiver device comprises a multiple-input and multiple-output, capable radio receiver device.

16. A method, comprising:
receiving, at a radio receiver device, a radio signal comprising information bits; and
determining, with the radio receiver device, log-likelihood ratios of the information bits,
wherein the determining of the log-likelihood ratios is performed with applying, with the radio receiver device, an iterative neural network to a frequency domain representation of the received radio signal over a transmission time interval, the iterative neural network comprising a single processing block iteratively executable to process the frequency domain representation of the received radio signal, and the iterative neural network configured to output estimates of the log-likelihood ratios based on the processing results of the single processing block.

17. A non-transitory program storage device readable with a radio receiver device, tangibly embodying a program of instructions executable with the radio receiver device to perform at least the following:
receiving a radio signal comprising information bits; and
determining log-likelihood ratios of the information bits,
wherein the determining of the log-likelihood ratios is performed with applying an iterative neural network to a frequency domain representation of the received radio signal over a transmission time interval, the iterative neural network comprising a single processing block iteratively executable to process the frequency domain representation of the received radio signal, and the iterative neural network configured to output estimates of the log-likelihood ratios based on the processing results of the single processing block.
